(19) United States
(12) Patent Application Publication
(10) Pub. No.: US 2013/0233580 A1
(43) Pub. Date: Sep. 12, 2013

(54) SMOOTH FORWARD FOLDING IMPLEMENT FRAME

(71) Applicant: Jon Kinzenbaw, Williamsburg, IA (US)

(72) Inventor: Jon Kinzenbaw, Williamsburg, IA (US)

(73) Assignee: Kinze Manufacturing, Inc., Williamsburg, IA (US)

(21) Appl. No.: 13/787,932

(22) Filed: Mar. 7, 2013

Related U.S. Application Data
(60) Provisional application No. 61/608,511, filed on Mar. 8, 2012.

(51) Int. Cl. A01B 73/06

(52) U.S. Cl. CPC A01B 73/065
USPC 172/1; 172/459

(57) ABSTRACT

A forward folding implement for connecting to a tow vehicle, such as a tractor, is provided. The implement includes a telescoping tongue for connection to the tow tractor. A main frame is connected to the telescoping tongue opposite the tow tractor and is supported by a plurality of wheels. Right and left wings are pivotally connected to the main frame and include a plurality of ground engaging tools attached thereto. First and second hydraulic cylinders are connected to the wings. The first cylinder pivots the wing about a vertical axis, while the second cylinder is configured to pivot the wing about a horizontal axis. The wings are raised about the horizontal axis before being placed in a transport position after being rotated about the vertical axis.

### CROSS-REFERENCE TO RELATED APPLICATIONS

This application claims priority under 35 U.S.C. §119 to provisional application Ser. No. 61/608,511, filed Mar. 8, 2012, which is herein incorporated by reference in its entirety.

### FIELD OF THE INVENTION

The present invention relates generally to a forward folding implement frame, and more particularly to a forward folding planter.

### BACKGROUND OF THE INVENTION

As the power of tractors and agricultural efficiency has increased, agricultural implements, such as planters have increased in span, or width, to accommodate larger numbers of individual row units. Large planters generally include a main frame having a forward hitch assembly for drawing by a tractor and left and right wing sections pivotally attached to a portion of the main frame. The pivoting wing connections allow the wings to fold relative to the main frame for transport and storage of the planter. Early planters pivotally displaced the wings vertically to reduce planter width and to provide clearance for transport through narrow spaces. However, as the size of planters has increased, planter wings are generally folded in a forward direction to accommodate longer planter wings or wing sections. This evolution has necessitated the incorporation of telescoping hitch assemblies and specific folding functions to accommodate planter wings of increased length.

The folding functions of such planters have, to varying degrees, operating limitations due to their design and the environment in which they operate. For example, a forward folding agricultural planter is capable of great operating widths, which make it a prime candidate for the gained efficiencies of bulk commodities, such as seed and fertilizer. To achieve the efficiencies of bulk commodities while facilitating forward folding of the planter, it is generally necessary to place the bulk commodities on the center frame of the machine near the road transport wheels. This location, in conjunction with the flex points of the toolbar, significantly loads the center portion of the planter and does not allow for adequate mass of the free-floating wings. The lack of mass or downforce on the wings may allow the resistance of the soil being penetrated by a ground-engaging tool to lift the wings and prevent the tools from penetrating the ground to a desired depth. Past attempts at addressing this problem have been to transfer weight from the center section to the wing by way of a hydraulic cylinder or other force-generating device.

Another operating limitation of current agricultural planters is that they require a series of sequential folding steps in order to move from a field use configuration to a secured road transport configuration. One step that can pose great difficulty is the latching of the wing sections at the hitch. Typically, this has been accomplished by lowering the front of the planter hitch as the wings fold toward the towing tractor, and then securing the wings by way of a latch or hook. When the hitch is raised for transport, the wing is supported and secured for transport. Such wings must be lifted off the ground and supported to achieve a secured transport configuration.

To secure the wings in a transport configuration, the wings must turn approximately 90° from field use configuration to transport configuration and travel over uneven and soft soil conditions. These soil conditions can hinder the wings from rotating. For instance, the wings, and the tires supporting wings, can sink into the soil to inhibit proper latching. Past attempts at addressing this problem have centered on using a combination of hydraulic cylinders for folding each wing, leading to additional expense. These fold cylinders impart a horizontal force on the wing, causing rotation of the wings towards the hitch and are separate and distinct from the hydraulic cylinders used to transfer weight from the center section to the wings. Moreover, the fold cylinders are typically oversized to force the wings through any uneven or soft soil conditions. Oversizing the hydraulic cylinders again leads to increased expense and requires additional structure to prevent damage to the hitch.

Therefore, there exists a need in the art for a means of forward folding the wing sections of an agricultural planter that overcomes the deficiencies in the art.

### SUMMARY OF THE INVENTION

Therefore, it is principal object, feature, and/or advantage of the present invention to provide an apparatus that overcomes the deficiencies in the art.

It is another object, feature, and/or advantage of the present invention to provide an apparatus, system and method to both assist in horizontal folding of an agricultural implement and transfer weight to the wings of the implement.

It is yet another object, feature, and/or advantage of the present invention to provide an agricultural implement with a hydraulic system that assists horizontal folding of the agricultural implement between a field use configuration and a transport configuration.

It is still another object, feature, and/or advantage of the present invention to provide an agricultural implement with a hydraulic system that assists in the latching of wings in a secured transport configuration when traveling over uneven and soft soil conditions.

It is a further object, feature and/or advantage of the present invention to provide an agricultural implement with a hydraulic system that transfers weight from the center section of the implement to its wings.

It is still a further object, feature, and/or advantage of the present invention to provide an agricultural implement with a lift system that provides continuous downforce on the wings to assist ground-engaging tools attached thereto in penetrating the soil at a desired depth.

According to one aspect of the invention, a forward folding implement connected to a tow tractor and having a transport configuration and a field use configuration is the provided. The frame includes, at least in part, a telescoping tongue for connection to the tow tractor; a main frame attached to the telescoping tongue away from the tow tractor, the main frame being supported by a plurality of ground engaging wheels; a wing pivotally coupled to the main frame and having a plurality of ground engaging tools attached thereto; a first hydraulic cylinder coupled between the main frame and the wing to pivot the wing with respect to the main frame about a substantially vertical axis; and a second hydraulic cylinder coupled to the wing to pivot the wing with respect to the wing support member about a substantially horizontal axis.

In an exemplary embodiment, the left and right wing sections include a wing support and a wing frame. Each wing includes a pair of hydraulic cylinders, a first hydraulic cylinder coupled between the wing support and the wing frame and a second cylinder coupled between the wing support and the main frame. The pair of hydraulic cylinders for each wing are utilized to transfer weight to the wings and to assist in folding the wings from field use to road transport configurations. A first hydraulic cylinder utilizes the cap end of the cylinder to generate a moment about the hinge point between the wing support and wing frame, to transfer weight from the center section to the wing. When the flow of hydraulic fluid is reversed such that pressure is placed on the rod side of the cylinder, uplift is created on the wings to assist in the folding from field use to road transport configurations. The uplift counteracts the soft or uneven soil conditions by lowering the amount of force present on the outboard wing wheels, thereby increasing the likelihood of successful latching for transport. A second hydraulic cylinder uses both the cap and rod ends to move the wing between field use and road transport configurations.

### BRIEF DESCRIPTION OF THE DRAWINGS

The appended claims set forth those novel features that characterize the invention. However, the invention itself, as well as further objects and advantages thereof, will best be understood by reference to the following detailed description of an embodiment taken in conjunction with the accompanying drawings, where like reference characters identify like elements throughout the various figures, in which:

FIG. 1 is a plan view of a foldable implement frame made in accordance with and embodying the principles of the present invention, the parts of the frame and hitch being shown in extended field use configuration;

FIG. 2 is a front plan view of the implement frame illustrated in FIG. 1;

FIG. 3 is an isometric view of implement frame illustrated in FIG. 1;

FIG. 4 is an isometric view of the foldable implement frame made in accordance with and embodying the principles of the present invention, the parts of the frame and hitch being shown between field use configuration and road transport configuration;

FIG. 5 is a side view of the implement frame illustrated in FIG. 4;

FIG. 6 is a plan view of the implement frame illustrated in FIG. 4;

FIG. 7 is an isometric view of a foldable implement frame made in accordance with and embodying the principles of the present invention, the parts of the frame and hitch being shown in road transport configuration;

FIG. 8 is a side view of the implement frame illustrated in FIG. 7;

FIG. 9 is a plan view of the implement frame illustrated in FIG. 7;

FIG. 10 is an enlarged perspective view of the latch assembly of the implement frame illustrated in FIG. 7;

FIGS. 11A and 11B are left and right wing sections of another embodiment of a implement frame; and

FIG. 12 is a top plan view of the implement frame of FIGS. 11A and 11B.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. In addition, it is understood that the phraseology and terminology used herein is for the purpose of description and should not be regarded as limiting.

### DETAILED DESCRIPTION OF THE PREFERRED EMBODIMENTS

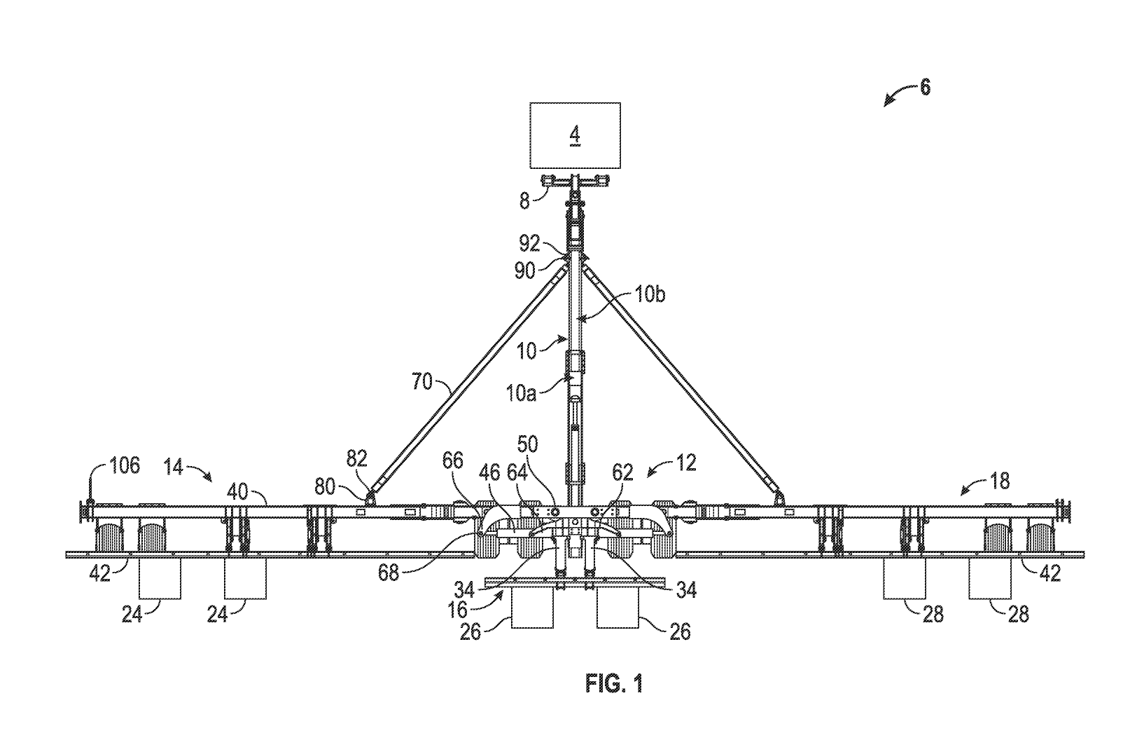

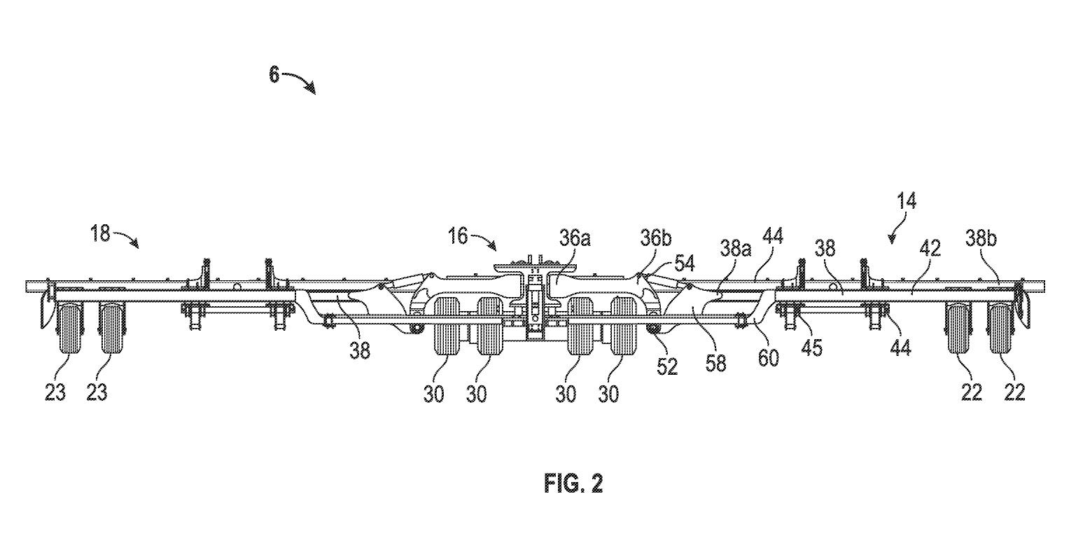

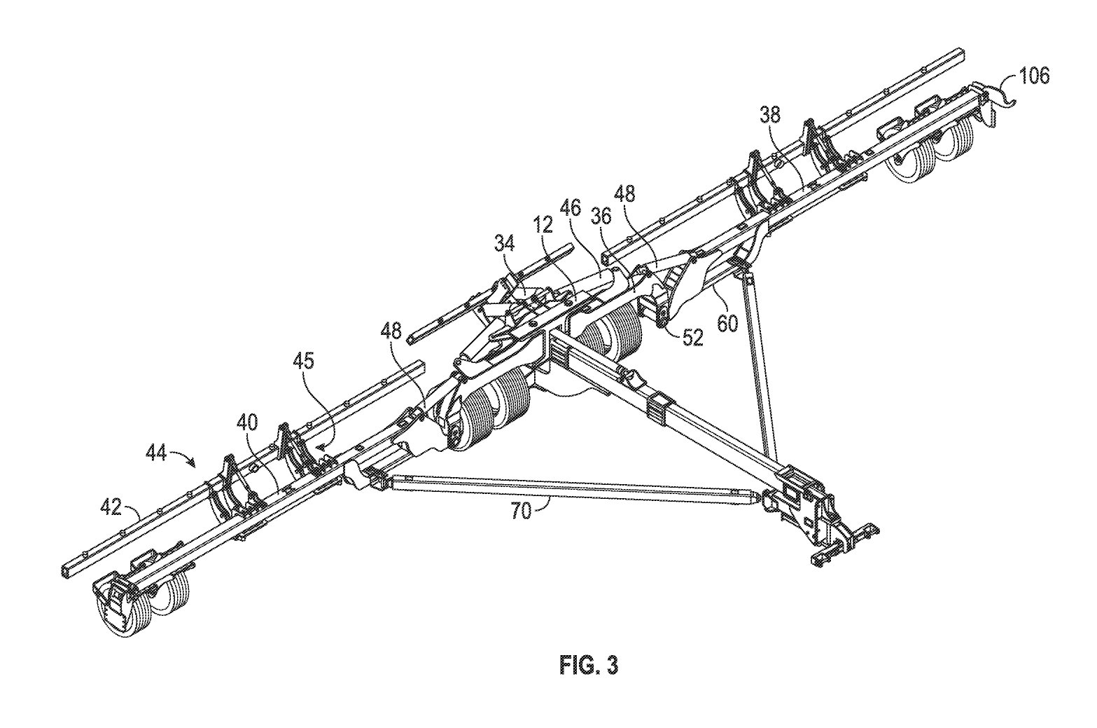

Referring to FIGS. 1-3, there is shown a foldable implement frame 6 in accordance with the aspects of the present invention. The implement frame 6 includes a hitch assembly 8, a telescoping tongue 10, and a main frame 12 mounted to and supported by wheels 30. The frame, for instance, may include four wheels, where all four wheels are shown in FIG. 2. Secured to the main frame 12 are a left wing 14, a center section 16, and a right wing 18. The terms left and right are used in relation to the direction of travel of the implement frame 6 during use in a field or during transport, and are included for references to the drawings. The directional terms used throughout the application are not to be limiting to the scope of the invention.

The telescoping tongue 10 extends longitudinally from the main frame 12 and includes telescoping tongue members 10a and 10b, with the outer tongue member 10a being hollow and of rectangular cross section and telescopically receiving therein an inner longitudinal tongue member 10b. It is to be appreciated that the telescoping tongue 10 may include more sections as well, depending on the length needed. The additional tongue sections can be hollow and received within one another to allow the length of the tongue to vary. At a forward end of the inner tongue member 10b is a bifurcated hitch assembly 8.

The hitch assembly is similar in configuration to that described in U.S. Pat. Nos. 6,408,950 and 6,902,010, which are incorporated herein by reference. The hitch assembly of the present invention is adapted to provide a connection for a two-point hitch to a tow vehicle, such as a tractor 4 to elevate the forward end of implement frame 6. An extendable drawbar may also be used in place of the two-point hitch.

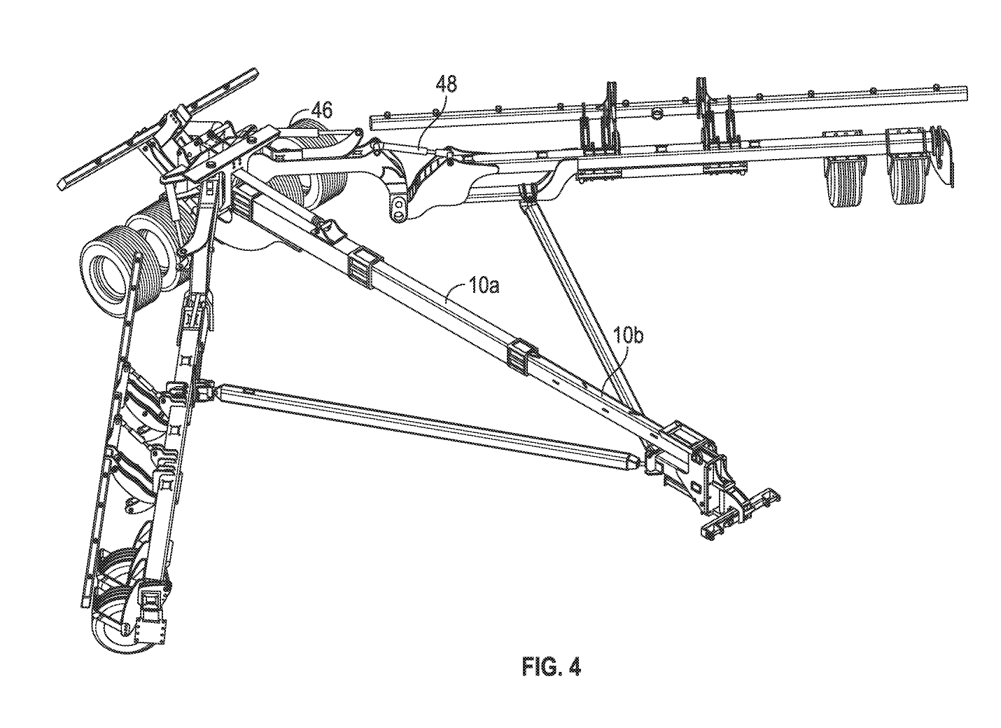

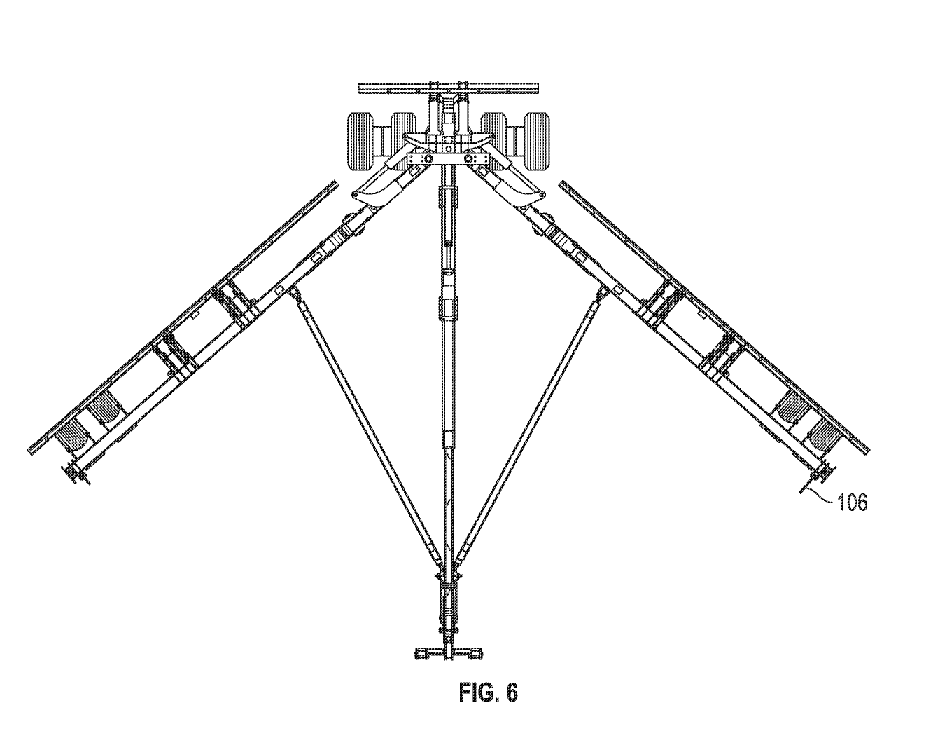

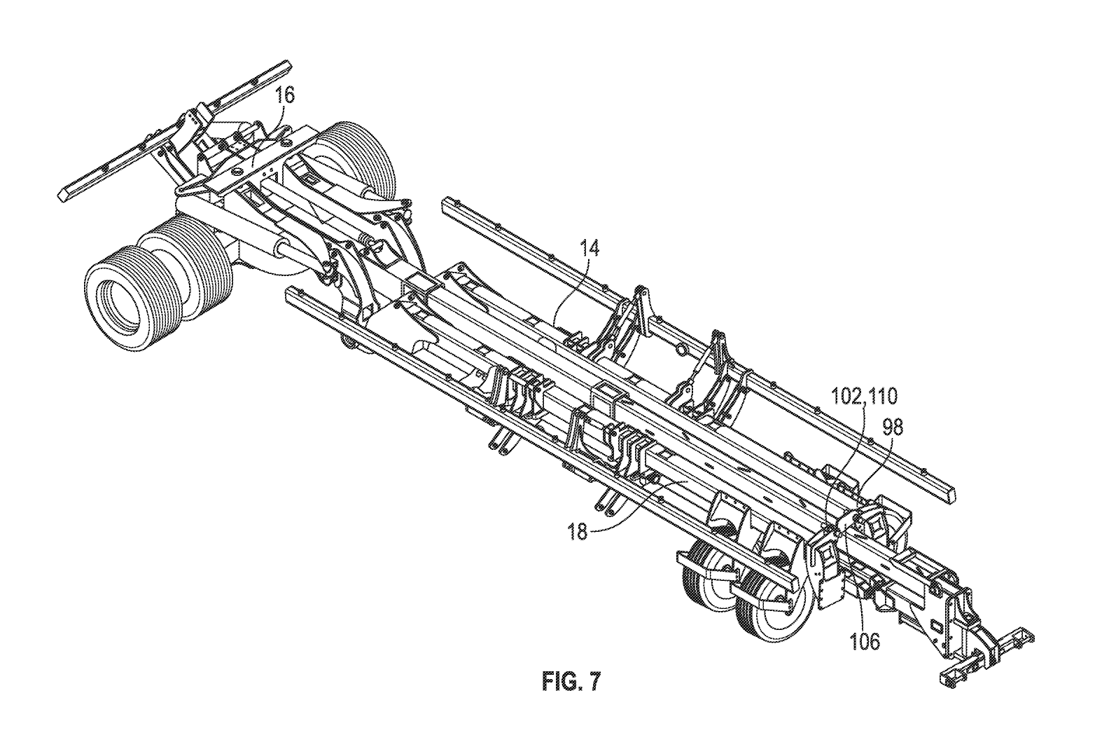

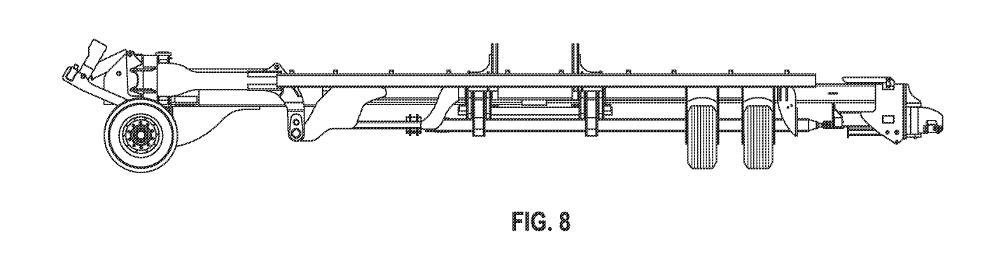

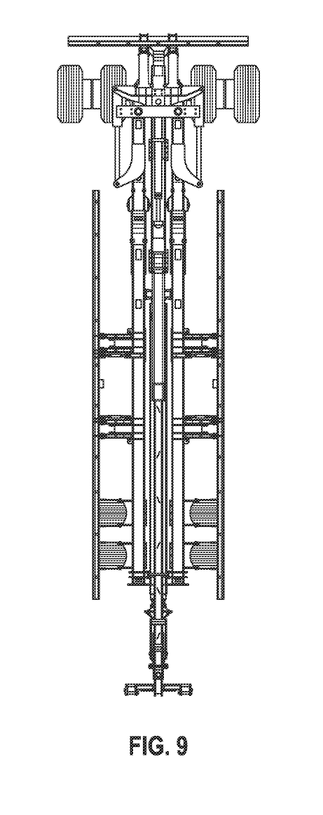

It should be noted that in a field use configuration, as shown in FIGS. 1-3, the wings are generally perpendicular to the tongue 10, while in a transport use configuration, as shown in FIGS. 7-10, the wings are generally parallel to the tongue 10. As the wings 14, 18 transition from the field use configuration to the transport configuration, as shown in FIG. 4-6, the tongue 10 telescopes to provide sufficient distance between the tractor 4 and the main frame 12 for the wings 14, 18 to come forward.

As shown in FIG. 1, the center section 16 is disposed on an aft end portion of main frame 12, i.e., opposite the hitch, and includes a plurality of row units 26 attached thereto by way of a conventional parallel linkage. Left and right wings 14, 18 are similarly provided with a plurality of row units 24, 28. Each row unit 24, 26, 28 is conventional in design and operation and includes furrow forming wheels, a seed dispensing arrangement with a discharge tube, furrow closing wheels, gauge wheels, as well as additional options used in the planting process. An example of a row unit for use with the present invention is found in U.S. Pat. No. 6,148,747, which is hereby incorporated in its entirety. However, any type of row unit could be used with the invention. The agricultural implement is not limited to a planter with row units, but instead could be adapted for use with any implement having folding wing extensions such as seed drills, cultivators, fertilizer and pesticide applicators, and the like.

The center section 16 is pivotally attached to the aft end portion of main frame 12 and can be raised and lowered by a pair of hydraulic cylinders 34 on the aft end portion of main frame 12. The center section 16 can be raised above its normal operating height during planting to facilitate on the go turning in the field or transport of the planter.

The left and right wings 14, 18 are similar to one another in design, operation, and in the manner in which they are pivotally attached to the implement's main frame 12. The following detailed description of the implement frame 6 addresses primarily the design and operation of only the left wing 14 for the sake of brevity.

The left wing 14 includes a wing support 36 and a wing frame 38. The wing frame 38 includes the combination of a forward bar 40 and a respective aft bar 42. The forward bar 40 is pivotally coupled to the aft bar 42 by means of an outer coupler 44 and an inner coupler 45. The aft bar 42 can be raised above its normal operating height during planting to facilitate on the go turning in the field or transport of the planter.

An inner end portion 36a of the wing support 36 is pivotally coupled to the main frame 12 at a pin 50 to allow for rotation of the left wing 14 about a vertical axis in a generally horizontal plane towards the towing tractor 4. A hydraulic cylinder 46 is connected at its cap end by a pin 64 to a mounting extension 62 extending rearward from main frame 12. At its rod end, the hydraulic cylinder 46 is connected by a pin 68 to a mounting extension 66 on the wing support 36. In one mode of operation, actuation of the hydraulic cylinder 46 moves the left wing 14 forwardly through a generally horizontal plane into a secured transport configuration.

An outer end portion 36b of the wing support 36 is pivotally coupled to an inner end portion 38a of the wing frame 38 via a pin 52 to allow for rotation of the wing frame 38 about a horizontal axis in a generally vertical plane by actuation of a hydraulic cylinder 48. The outer end portion 36b of the wing support 36 extends horizontally from the main frame 12 and curves downward until it is substantially vertical. The inner end portion 38a of the wing frame 38 includes an upper member, forward bar 40, and lower member 60 coupled thereto. The hydraulic cylinder 48 is pivotally connected at its cap end to an extension 54 on the wing support 36. At its rod end, the hydraulic cylinder 48 is pivotally connected to mounting plates 58 on the inner end portion 38a. In one mode of operation, actuation of the hydraulic cylinder 48 moves the wing frame 38 downwardly through a generally vertical plane, thereby transferring weight from the main frame 12 to the wing frame 38. In another mode of operation, the flow of hydraulic fluid is reversed through the hydraulic cylinder 48 such that wing frame 38 moves upwardly through a generally vertical plane. By rotating the wing upward, weight on the wing frame 38 is transferred to the main frame 12 and the wing frame 38 is able to more easily travel over uneven and soft soil conditions, thereby aiding in folding and latching of implement frame 6. The right wing 18 is similarly, pivotally attached to the main frame 12 and rotated through horizontal and vertical planes in the same manner as left wing 14.

It should be appreciated that the cylinders 48 can provide a wide range of movement of the right and left wings 14, 18. For example, as discussed above, the cylinders can provide a down force pushing the wings below horizontal. The cylinders can also raise the wings, potentially up to 90° above horizontal. However, one aspect of the invention provides that the cylinders 48 move the wings 14, 18 between (−45°) and 45° relative to the horizontal, while a preferred aspect provides for movement between (−21°) and 21° relative to the horizontal.

The transfer of the weight of the wing frame 38 to the main frame 12 during or before the forward folding movement of the wing 38 has many advantages. Because the wing 38 will have less ground resistance, less force will be required to move the wing. Therefore, a smaller cylinder 46 may be used with the implement for moving the wing 38 forward. The smaller cylinder equates to less weight for the implement 6 and makes for a less expensive implement. Furthermore, as the wing 38 has less resistance during the forward folding process, there is less likelihood that the wing will be snagged or temporarily stopped by the ground. This is advantageous, as at present, when a snag occurs, excess force is required to overcome the snag, which can cause the wing to violently slam against the tongue 10 or other components of the implement 6. The slamming can damage the components. Thus, another aspect of the invention is that the smooth forward folding of the present invention may also increase the life of components of the implement 6 by reducing the wear and tear caused by inadvertent slamming during the forward folding process.

Referring to FIG. 2, an outer end portion of the left wing 14 is supported by a wheel assembly 22. Similarly, an outer end portion of the right wing 18 is supported by a second wheel assembly 23. The wheel assembly 22 includes a bracket fixedly secured to the forward bar 40 of the wing frame 38 at an outer end portion 38b. The wheel assembly 22 may also be longitudinally slidable along the wing frame 38. The wheel assemblies support the outer ends of the associated wings during the movement of the wings 14, 18 between a field use configuration and transport configuration. To assist in holding the folding wings 14 and 18 in the fully extended and field use configuration illustrated in FIGS. 1-3, each of the wings 14 and 18 has been provided with a wing brace 70. The left wing brace 70 is pivotally secured by a pivot pin 82 to a bracket 80 on lower member 60 of the wing frame 38, which includes two spaced apart members (not shown) each having an attachment portion. The opposite end of the wing brace 70 is pivotally secured by a ball joint (not shown) of a stabilizer lock assembly 90 similar to that described in U.S. Pat. No. 6,902,010, which is hereby incorporated in its entirety.

The folding process begins with the implement in the field use configuration, as shown in FIGS. 1-3. In this configuration, the wings extend outwardly and are generally perpendicular to the tongue 10. Referring to the left wing 14, the aft bar 42, and the row units 24 attached thereto, is pivoted upward relative to the forward bar 40. Next, the operator disengages a mechanism holding the tongue members 10a and 10b in the retracted, coupled position shown in FIGS. 1-3. The tongue 10 is then free to telescopically extend via the combined movement of the tow tractor 4 and extension of the hydraulic cylinder 46 to provide sufficient distance between the tow tractor 4 and the main frame 12 for the wings 14, 18 to fold forward. As shown in FIGS. 4-6, as the tongue telescopically extends, the wing braces 70 extend the inner tongue member 10b from the outer tongue member 10a, moving the wings 14, 18 forward towards a transport position. As the outer ends of the wings 14, 18 approach the tongue and each other, the wing braces 70 fold underneath the tongue 10, freeing up space between the wings 14, 18 and the tongue 10. Furthermore, actuation of the hydraulic cylinder 48 during the folding process transfers weight from the wing frame 38 to the main frame 12 to allow the wing frame 38 to more easily travel over uneven and soft soil conditions, thereby aiding in folding and latching of the implement frame 6.

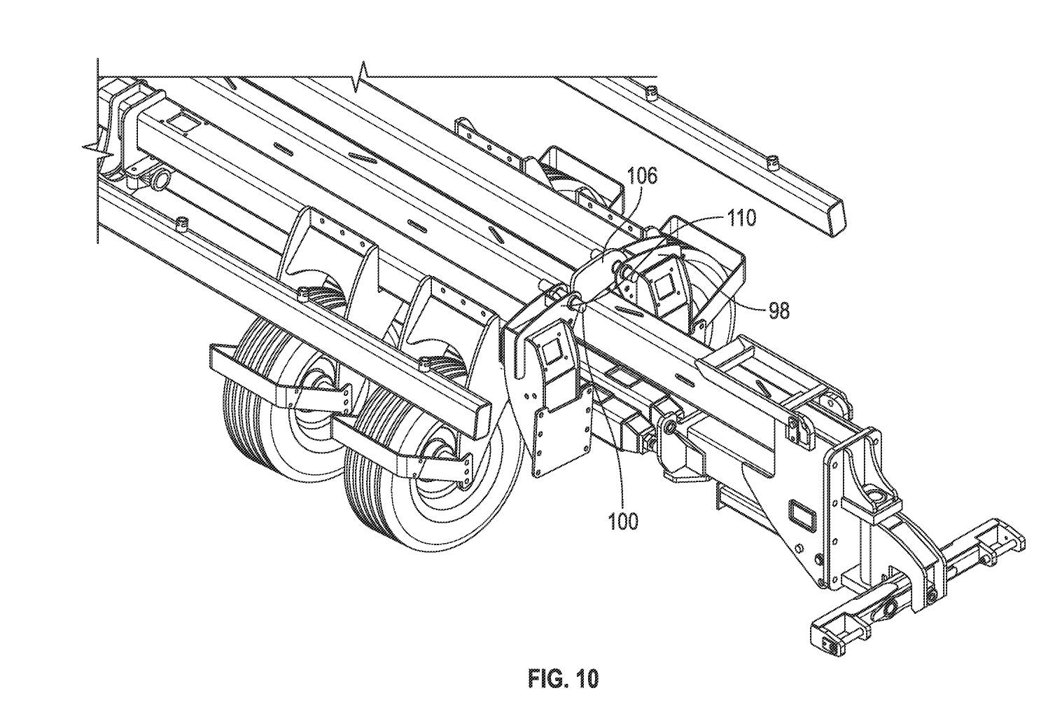

When the implement frame 6 is in the folded transport position, as illustrated in FIGS. 7-9, it may be desirable to lock the left and right wings 14, 18 to each other over top of the tongue 10 with a latch assembly 98, as best illustrated in FIG. 10, such that the wings will remain in said position during transport. There is provided a transport link 100 that is pivotally secured at one end thereof between two brackets 102 on a left wing 14 by means of a pivot pin 104. The other end of the transport link 100 carries an upwardly extending latch 106 having an abutment surface that is inclined generally upwardly. The right wing 18 carries two upstanding flanges 110 adapted to receive therebetween the latch 106 on the transport link 100. A pin is fixedly secured between the flanges 110 and is adapted to be engaged by the latch 106 when the parts are placed in the position illustrated in FIG. 7.

As the wings 14, 18 move from the positions illustrated in FIGS. 1-3 to that illustrated in FIGS. 7-9, the transport link 100 is in a down or essentially horizontal position that slightly declines downwardly and is held in that position by a stop (not show). As the two wings 38 approach each other, a cam surface between the upstanding flanges 110 is contacted by the abutment surface of the latch 106. The latch 106 then rotatably engages the pin. To place the implement frame 100 in the transport position, the operator actuates the two-point hitch assembly or extendable drawbar 8, thus lifting the tongue 10 and main frame 12 against the underside of the transport link 100. This also lifts the wings 14, 18 and the attached parts. The transmittal of the weight of the wings 14, 18 and the attached parts to the transport link 100 further serves to lock the transport link 100 in the wing retaining positions shown in FIGS. 7-9.

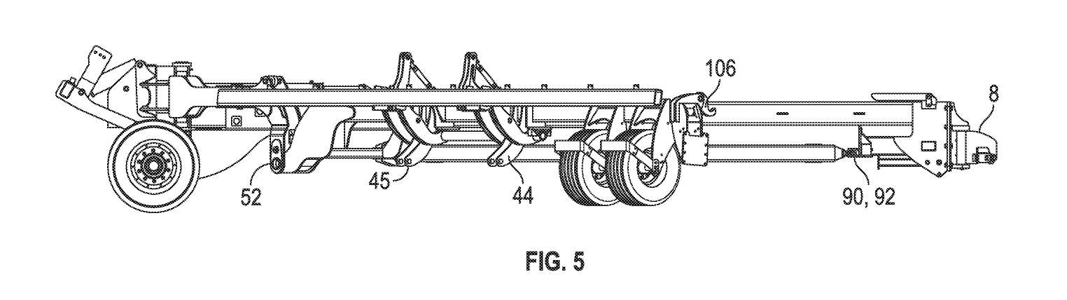

As shown in the figures, the latch 106 is positioned at the proximal end of the left wing 14. However, it should be appreciated that the latch 106 may be positioned at the proximal end of either the right or left wing. FIG. 5 shows the latch on the right wing, while the other figures show the latch on the left wing. The purpose of the latch 106 is to engage the pin to aid in connecting the right and left wings 14, 18 during the transport configuration of the implement. Furthermore, the latch may be orientated such that it is upward facing (concave generally upward) or downward facing (concave downward). Either orientation will allow the latch 106 to engage the pin to lock the wings in the transport configuration.

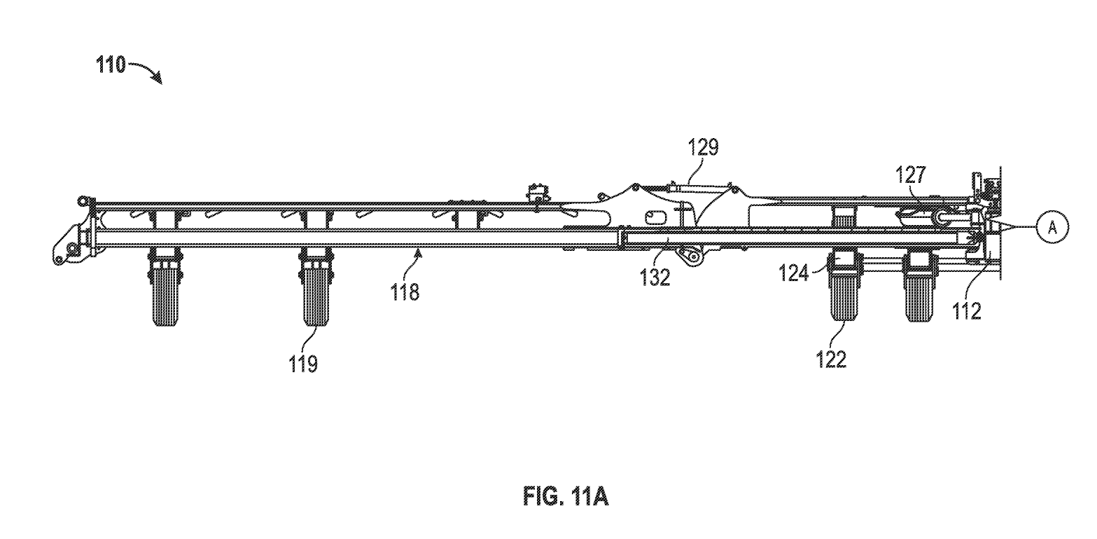

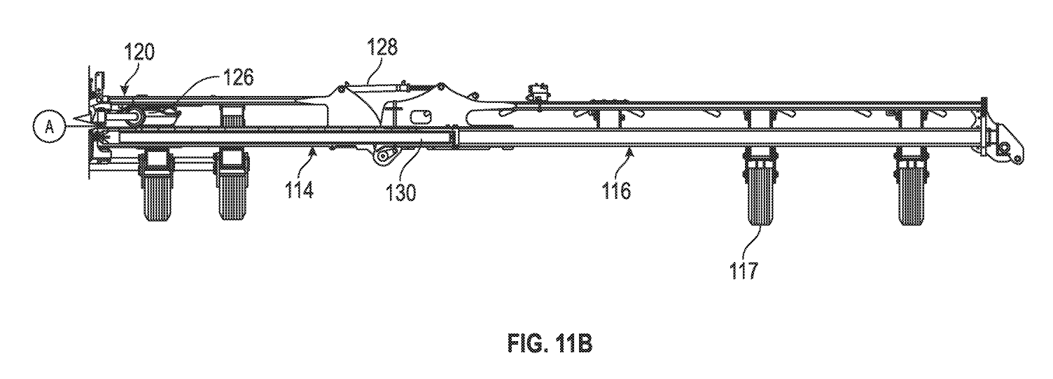

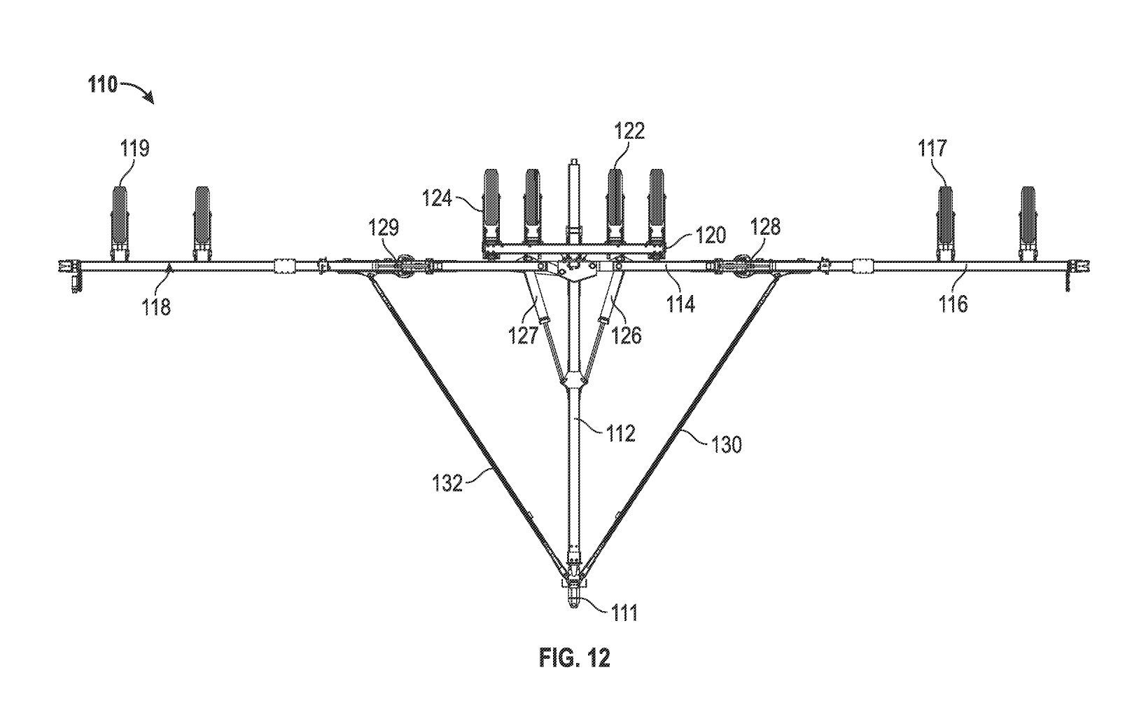

FIGS. 11A, 11B, and 12 show another embodiment of a planter frame 110 incorporating the novel aspects of the present invention. FIGS. 11A and 11B are sections of the implement frame 110, which are split at “A”, in order to better show the sections and their components. As shown in the figures, the frame 110 comprises many of the same components as the frame shown in FIGS. 1-10. The frame 110 includes a tongue 112 extending between a hitch 111 and a main frame 114. A left wing 116 and a right wing 118 extend from the main frame 114, and are hingably connected thereto. The left wing 116 includes wheels 117 and the right wing 118 includes wheels 119. A center section 120 is positioned generally aft of the main frame portion 114, and includes a plurality of wheels 122. Each of the wings 116, 118, as well as the center section 120 will include a plurality of row units (not shown), as mentioned above. However, the wheels 122 at the central portion may also include an assembly 124 that will rotate the axle of the wheels 122. This can raise and lower the central portion between a field use and transport use, and can also aid in turning the frame 110.

Each of the wings 116, 118 will be operatively attached to the main frame 114 via a hydraulic cylinder 128 positioned between the wing and the main frame. Similar to the cylinders 48 above, the cylinder 128 will provide a lifting and downforce for the left and right wings 116, 118 in relation to the main frame 114. This will account for variations in ground hardness, as well as providing a method for easier turning of the frame 110 in the field and for forward folding the wings of the frame to a transport configuration.

The frame 110 also includes first and second cylinders 126 positioned between the left and right sections of the main frame 114 and the tongue 112. The tongue 112 may be telescoping or fixed in length. Positioned generally from the wings 116 to the tongue 112 are left and right braces 130, 132, which further aid in the folding of the wings.

The folding and unfolding of the frame 110 between a field use configuration and a transport configuration can be as follows. The frame 110 in FIGS. 11A, 11B, and 12 is in a field use configuration. To fold forward to a transport configuration, the cylinders 128, 129 are retracted to reduce the down pressure on the wings 116, 118 and to slightly lift said wings. The tongue cylinders 126, 127 then begin retracting their piston, which is connected to a fixed coupling on the tongue. Thus, the wings will be drawn towards the coupling, which causes the wings 116, 118 to rotate towards one another at the tongue 112. The wing braces 130, 132 may be telescoping members such that their length can be reduced as the wings are folded toward one another. The wings 116, 118 can then be locked to the tongue 112 to hold the wings in place during transport. Furthermore, the wheels 122 of the central section 120 can be rotated to shorten the distance between the wheels 122 and the hitch 111, which aids in transport of the frame 110.

It should also be understood that the features of any of the exemplary embodiments illustrated and described herein may be incorporated into any of the other exemplary embodiments illustrated and described herein in any combination and without any limitation.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

What is claimed is:

1. A forward folding implement connected to a tow tractor and having a transport configuration and a field use configuration, the implement comprising:
a telescoping tongue configured to connect to the tow tractor;
a main frame attached to the telescoping tongue opposite the tow tractor, the main frame being supported by a plurality of ground engaging wheels;
a wing pivotally coupled to the main frame and having a plurality of ground engaging tools attached thereto;
a first hydraulic cylinder coupled between the main frame and the wing to pivot the wing with respect to the main frame about a substantially vertical axis; and
a second hydraulic cylinder coupled to the wing to pivot the wing with respect to the wing support member about a substantially horizontal axis.

2. The implement of claim 1 further comprising a wing support with first and second ends and a wing frame with first and second ends, wherein the first end of the wing support is pivotally coupled to a center portion of the main frame and the second end of wing support is pivotally coupled to a first end of the wing frame.

3. The implement of claim 2 wherein the first hydraulic cylinder is coupled between the main frame and the wing support to pivot the wing support with respect to the main frame about a substantially vertical axis.

4. The implement of claim 2 wherein the second hydraulic cylinder is coupled between the wing frame and the wing support member to pivot the wing with respect to the wing support member about a substantially horizontal axis.

5. The implement of claim 1 further comprising a wing brace extending from the wing to the telescoping tongue.

6. The implement of claim 1 wherein the wing positioned substantially perpendicular to the tongue in the field use configuration, and substantially parallel to the tongue when in the transport configuration.

7. The implement of claim 1 wherein the telescoping tongue comprises a plurality of sections configured to be inserted into one another and extendable or retractable to provide a telescoping length for the tongue.

8. The implement of claim 1 further comprising a second wing pivotally coupled to the main frame and extending therefrom in an opposite direction than the first wing when in the field use configuration.

9. The implement of claim 8 further comprising a plurality of ground engaging tools attached to the second wing.

10. The implement of claim 9 further comprising first and second hydraulic cylinders operatively attached between the second wing and the main frame to move the wing both vertically and horizontally.

11. The implement of claim 10 wherein in the transport configuration, the first and second wings are substantially adjacent one another at the tongue.

12. A method of folding first and second wings of an implement between a field use configuration and a transport configuration, the method comprising:
providing an implement having a telescoping tongue connected to a main frame, first and second wings extended from the main frame and away from the tongue in the field use configuration, and each wing coupled to the main frame via first and second cylinders;
raising at least a portion of the first and second wings via the second cylinders; and
rotating the first and second wings towards the tongue as the tongue telescopes to a longer length to position the wings in the transport configuration.

13. The method of claim 12 further comprising locking the first and second wings to one another when in the transport configuration to hold them in place during transport.

14. The method of claim 12 further comprising at least partially raising a plurality of ground engaging tools connected to the first and second wings before raising the wings and moving to the transport configuration.

15. The method of claim 12 wherein the first and second wings comprise a plurality of wheels attached to the wings.

16. The method of claim 15 wherein the wing wheels remain, at least partially, in contact with the ground during transition from the field use configuration to the transport configuration.

17. An implement configured to be towed by a vehicle and having a field use configuration and a transport configuration, the implement comprising:
an extendable tongue comprising a hitch at one end and a main frame at the opposite end, the main frame including wheels extending therefrom;
first and second wings operatively attached to the main frame and comprising ground engaging tools and wheels extending therefrom;
wherein the first and second wings movable from a field use configuration wherein the wings are substantially perpendicular to the tongue to a transport configuration wherein the wings are substantially parallel to the tongue; and
wherein the wings include a cylinder configured to move the wings between a downforce position wherein the wings are at least partially below horizontal and a moving position wherein the wings include a portion at least partially above the horizontal to aid in folding the wings to the transport configuration.

18. The implement of claim 17 wherein the extendable tongue includes telescoping sections to change the length of the tongue.

19. The implement of claim 17 further comprising first and second wing braces extending between the first and second wings and the tongue, wherein the wing braces change the length of the tongue during moving of the wings between the field use configuration and the transport configuration.

20. The implement of claim 17 further comprising a latching assembly operatively connected to the first and second wings and comprising a latch configured to lock the wings in place at the tongue in the transport configuration.
